(19) United States
(12) Patent Application Publication
(10) Pub. No.: US 2005/0053254 A1
(43) Pub. Date: Mar. 10, 2005

(54) Condenser microphone using space efficiently and having no characteristic variations

(76) Inventor: Ju Yeon Kim, Seoul (KR)

Correspondence Address: ST. ONGE STEWARD JOHNSTON & REENS, LLC, 986 BEDFORD STREET, STAMFORD, CT, 06905-5619, US

(21) Appl. No.: 10/936,364

(22) Filed: Sep. 8, 2004

(30) Foreign Application Priority Data
Sep. 8, 2003 (KR) 2003-62785
Nov. 17, 2003 (KR) 2003-81198

(51) Int. Cl. H04R 25/00; H04R 11/04

(52) U.S. Cl. 381/369; 381/355

(57) ABSTRACT

According to the present invention, the horizontal sections of the components of the condenser microphone are formed in an elliptical or a running track shape while the area of a diaphragm responding to sound pressure is maintained to be equal to or larger than a certain size, thus preventing a reduction in sensitivity to sound pressure as well as occupying the minimum internal space of each of various electronic products that trend toward miniaturization and thinness. Furthermore, a circular raised portion is formed at the center of the horizontal part of the casing, or a groove having an arcuate, triangular or rectangular section is formed on the horizontal part of the casing, so that the flatness of the casing and the gap between a diaphragm and a backplate are uniformly maintained, thus preventing the variations in the characteristics of the condenser microphone.

This application claims priority from pending Korean Patent Application Nos.2003-62785 filed on Sep. 8, 2003 and 2003-81198 filed on Nov. 17, 2003.

### FIELD OF THE INVENTION

The present invention relates generally to a condenser microphone for converting the variations of electrostatic capacitance formed by sound pressure into electric signals. More particularly, the present invention relates to an elliptical-shaped condenser microphone using space efficiently and having no characteristic variations, in which the horizontal section thereof is formed in an elliptical shape, thus preventing a reduction in sensitivity to sound pressure as well as occupying the minimum internal space of each of various electronic products that trend toward miniaturization and thinness. Furthermore, the present invention relates to an elliptical-shaped condenser microphone using space efficiently and having no characteristic variations, in which a circular or an elliptical raised portion, or a circular-, triangular- or rectangular-shaped groove is formed on the horizontal part of the casing, so that the flatness of the casing and the gap between a diaphragm and a backplate are uniformly maintained, thus preventing the variations in the characteristics of the condenser microphone.

### BACKGROUND ART

Generally, a condenser microphone is a microphone using variations in the electrostatic capacitance of a parallel-plate condenser, in which a backplate is placed on one side and a conductive diaphragm is placed on another side to be opposite to the backplate. A high Direct Current (DC) voltage is applied between the two plates through a resistance of tens of KΩ. Accordingly, variations in the gap between the two plates due to sound pressure are exhibited in the form of variations in electrostatic capacitance between the plates, and the variations in electrostatic capacitance are converted into electric signals.

The frequency characteristics of the condenser microphone are almost flat up to the vicinity of 30 kHz. The condenser microphone is of a high fidelity, but has a low output. Recently, the condenser microphone is widely applied to mobile communication terminals, such as mobile phones and personal digital assistants (PDAs), as well as devices for measurement and broadcasting.

The operational theory and principle of such a condenser microphone are described below. Since the internal components of the condenser microphone are very precise and sensitive to external electrical noise, the internal components are stacked and sealed within a metallic casing, in which sound wave inlets are formed, to be sufficiently protected from dust, contaminants or electrical noise.

When sound waves are applied to a film metal diaphragm through the sound wave inlets, variations in the distance between the diaphragm and the backplate, that is, variations in the distance caused by the sound waves, occur if the diaphragm is vibrated, and variations in electrostatic capacitance can be detected by converting the phenomenon of such physical variations into electrical form.

Generally, since the condenser microphone has small electrostatic capacitance and high electrical impedance, the condenser microphone cannot be used while directly being connected with a general amplifier, so that the condenser microphone is generally used in conjunction with a field effect transistor (FET), which is an impedance converting element, to be matched to input impedance required by the amplifier.

In this case, the FET is an active element formed of three terminals of a source, a gate and a drain, in which a current flowing between the drain and source varies depending on variations in the electric potential of the gate, so that the FET constitutes the basic operation circuit of an electrostatic condenser microphone system (ECMs), and thus, electric signals attributable to sound waves can be obtained. The condenser microphone requires an externally supplied DC power of hundreds of volts that is a polarization voltage. However, the ECMs is a type of non-polar condenser microphone, in which a metal is deposited on a high polymer film having excellent electric charge accumulation characteristics and the high polymer film deposited with the metal is used as a diaphragm, or a high polymer film is attached to a backplate, so that electric charges are accumulated thereon and thus it allows a supply of DC power to be unnecessary.

Each of the components constituting the condenser microphone, such as the casing, the diaphragm plate, the diaphragm, the spacer, the backplate, the connection ring, the base and the PCB, is separately manufactured to meet the characteristics thereof.

Of the above-arranged components, the casing surrounding the outer portion of the condenser microphone, that is, being located at the outermost location of the condenser microphone, is put on a separate work table. At this time, the opened portion of the casing faces upward. The diaphragm plate, the diaphragm, the spacer, the backplate, the connection ring, the base and the PCB are sequentially contained in the casing put on the work table, and thereafter, the uppermost edge of the casing is bent inward using a separate jig, thus completing the process of manufacturing the condenser microphone.

However, in the process of inwardly bending the uppermost edge of the casing to secure the components contained in the casing, pressure directed inward and downward is inevitably applied to the uppermost edge of the casing. The applied pressure acts not only as a force by which the uppermost edge of the casing is bent inward, but also as a force that is transmitted to the horizontal part of the casing along the vertical part of the casing and causes the horizontal part of the casing to bend.

In other words, when the upper portion of the casing is pushed inward from the side of the casing, an inward force is applied to the upper portion of the casing and an outward force is applied to the lower portion of the casing, so that there occurs a phenomenon in which the center of the horizontal part of the casing having a simple plane shape easily droops downward, and at the same time the diaphragm plate, the diaphragm, the backplate, the connection ring, the base and the PCB contained in the casing are bent downward or upward.

Accordingly, the initially designed gap between the diaphragm and the backplate is changed, so that the characteristics of the condenser microphone vary from an initial design. That is, the gap between the diaphragm and the backplate cannot remain uniform, thus responding differently to sound entering from different directions.

Furthermore, in accordance with a trend toward the miniaturization of electronic products, such as mobile phones and PDAs, the arrangement and configuration of components located in the casing has been changed and improved. However, the horizontal section of the casing still remains in a circular shape, and thus the internal spaces of electronic products are not efficiently used.

That is, the space, which is formed inside each electronic product, such as a mobile phone or PDA, to allow the condenser microphone to be located therein, is formed at the end portion of the electronic product to have a rectangular shape, whereas the horizontal section of the condenser microphone maintains a circular shape, so that the rectangular-shaped space cannot be efficiently used. Especially, since the size of the horizontal section of the condenser microphone must be equal to or larger than a certain size to obtain proper response sensitivity to the sound waves, a reduction in the diameter of the condenser microphone is limited, so that it is impossible to reduce the space occupied by the condenser microphone in the electronic product in prior arts.

### DISCLOSURE OF THE INVENTION

Technical Problem

An object of the present invention is to provide a condenser microphone, in which the horizontal section thereof is formed in an elliptical shape, so that the horizontal section thereof, especially the horizontal section of a diaphragm, is increased without an increase in the diameter of the condenser microphone, thus maximally increasing sensitivity to sound pressure as well as occupying the minimum internal space of each of various electronic products. In particular, the object of the present invention is to reduce the size of the condenser microphone while enhancing the characteristics of the condenser microphone.

Furthermore, another object of the present invention is to provide a condenser microphone, in which the a circular or an elliptical raised portion is formed at the center of the horizontal part of the casing that corresponds to the outer cover of the condenser microphone, or a groove having a triangular, rectangular or arcuate section is formed on the horizontal part of the casing, thus preventing the horizontal part of the casing from drooping or being bent upward or downward in spite of external pressure applied at the time of performing a curling step during a process of manufacturing the condenser microphone.

Furthermore, still another object of the present invention is to provide a condenser microphone, in which the deformation of the horizontal part of the casing is prevented, so that the deformation of a diaphragm plate, a diaphragm, a spacer, a backplate, a connection ring, a base and a PCB contained in the casing can be prevented, and the gap between the diaphragm and the backplate can be uniformly maintained, thus preventing the variations in the characteristics of the condenser microphone.

Furthermore, still another object of the present invention is to provide a condenser microphone, in which the gap between the diaphragm and the backplate is uniformly maintained, thus uniformly responding to sound entering from all directions regardless of the direction in which the sound enters through the sound inlets of the casing.

Furthermore, still another object of the present invention is to provide a condenser microphone in which the gap between the sound wave inlets and the diaphragm is formed to be as small as possible, so that the diaphragm can vibrate evenly in response to low surrounding sound pressure, thus increasing the response sensitivity of the condenser microphone.

Technical Solution

A condenser microphone using space efficiently and having no characteristic variations according to the present invention is characterized by including a metallic casing that has an elliptical-shaped horizontal section, has a container shape through which sound wave inlets are perforated on the lowermost plane thereof, and has an uppermost edge inwardly bent to secure components; a diaphragm plate that is located inside the casing, maintains a space inside the casing to allow a diaphragm to be vibrated by sound waves entering through the sound wave inlets, grips the outer portion of the diaphragm, and has an elliptical-shaped horizontal section; a diaphragm that is located on the diaphragm plate, is vibrated by the sound waves entering through the sound wave inlets, and has a film metal plate, on which electric charges are accumulated, on a whole surface of the diaphragm; a spacer made of an insulation material that is located on the diaphragm, and maintains an air gap between the diaphragm and a backplate to allow the diaphragm to be vibrated by the sound waves; a base made of an insulation material that is located on the spacer, supports the components while preventing movement of the components so that insulation is maintained between the casing and the backplate and between the casing and the connection ring, and prevents the deformation of an entire configuration; the metallic backplate that is formed in a film shape, on which electric charges are accumulated, on a side of the backplate opposite to the diaphragm, has a plurality of perforations formed therethrough, has an elliptical-shaped horizontal section, and is located inside the base to maintain a predetermined air gap with the diaphragm using the spacer; a connection ring that is located in the base and on the backplate, and connects the gate of a matching FET to the backplate; a PCB that has patterns made of conductive material thereon, is inserted into the casing to be electrically connected to the casing and the connection ring, and has an elliptical-shaped horizontal section; and the FET that is attached to the PCB, converts and amplifies variations in electric potential, which is attributable to variations in electrostatic capacitance between the diaphragm and the backplate caused by vibrations of the diaphragm, into electric signals.

In accordance with the present invention, it is preferable that the casing has a length L of 4.2 to 4.8 mm and a width W of 2.5 to 3.1 mm.

In accordance with the present invention, it is preferable that the condenser microphone further includes a filter that is located in the lower portion of the casing to prevent dust, moisture or contaminants from entering the inside of the casing through the sound wave inlets.

In accordance with the present invention, it is preferable that a circular or an elliptical raised portion whose location is higher than that of the surrounding thereof is formed at the center of the horizontal part of the casing.

In accordance with the present invention, it is preferable that a groove having a triangular, rectangular or arcuate section is formed on the horizontal part of the casing while remaining spaced apart from the vertical part of the casing by a predetermined distance.

In accordance with the present invention, it is preferable that the horizontal part of the casing has a circular or an elliptical shape.

Advantageous Effects

According to the present invention, the horizontal section of a condenser microphone is increased and formed in an elliptical shape so as to correspond to the internal space of an electronic product, such as a mobile phone or PDA, so that the present invention is effective in that sensitivity to sound pressure is not reduced while the condenser microphone occupies the minimum internal space of the electronic product. In particular, the sensitivity of the condenser microphone is increased and the size thereof is minimized, so that the present invention can contribute toward the implementation of high-quality and miniaturized mobile communication terminals and electronic products in which such condenser microphones are mounted, such as mobile phones and PDAs.

Furthermore, according to the present invention, a circular or an elliptical raised portion whose location is higher than that of the surrounding thereof is formed at the center of the casing that corresponds to the outer portion of the condenser microphone, or a groove having a triangular, rectangular or arcuate shape is formed, so that the present invention is effective in that the horizontal part of the casing is prevented from drooping or being bent upward or downward in spite of external pressure applied at the time of performing a curling step during a process of manufacturing the condenser microphone.

Furthermore, according to the present invention, the deformation of the horizontal part of the casing is prevented, so that the deformation of a diaphragm plate, a diaphragm, a spacer, a backplate, a connection ring, a base and a PCB contained in the casing are prevented, so that the present invention is effective in that the gap between the diaphragm and the backplate are uniformly maintained, thus preventing the variations in the characteristics of the condenser microphone.

Furthermore, according to the present invention, the gap between the diaphragm and the backplate is uniformly maintained, thus uniformly responding to sound entering from all directions regardless of the direction of the sound entering through the sound inlets of the casing.

Furthermore, according to the present invention, the gap between the sound wave inlets and the diaphragm is formed to be small as possible, so that the present invention is effective in that the diaphragm can vibrate evenly due to low surrounding sound pressure, thus increasing the response sensitivity of the condenser microphone.

### BRIEF DESCRIPTION OF DRAWINGS

FIG. 1 is a perspective view showing an elliptical-shaped condenser microphone using space efficiently and having no characteristic variations according to the present invention;

FIG. 2 is an exploded perspective view showing the elliptical-shaped condenser microphone using space efficiently and having no characteristic variations according to the present invention;

FIG. 3 is a plan view showing one side of a PCB that is required for soldering, and FIG. 4 is a bottom view showing the other side of the PCB on which patterns are formed;

FIG. 5 is a sectional view showing the elliptical-shaped condenser microphone using space efficiently and having no characteristic variations according to the present invention;

FIG. 6 is a cut-away perspective view showing a casing according to an embodiment of the present invention;

FIG. 7 is a sectional view showing a condenser microphone having the casing of FIG. 6; and

FIG. 8 is a sectional view showing a condenser microphone having a casing according to another embodiment of the present invention.

### BEST MODE FOR CARRYING OUT THE INVENTION

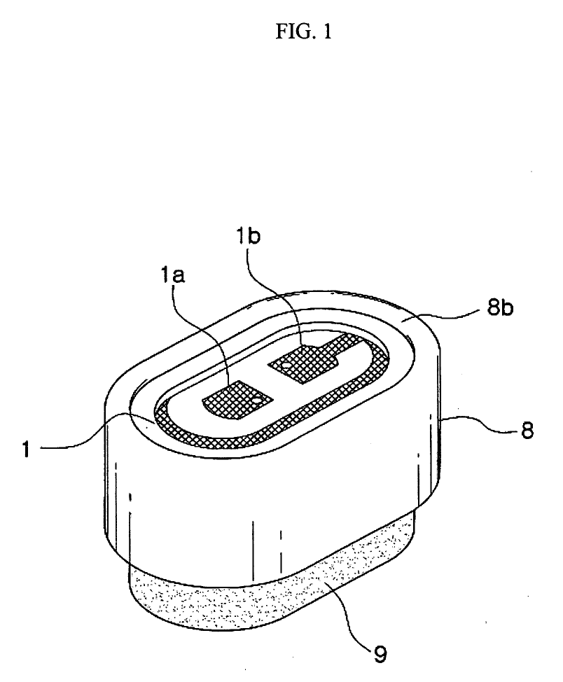

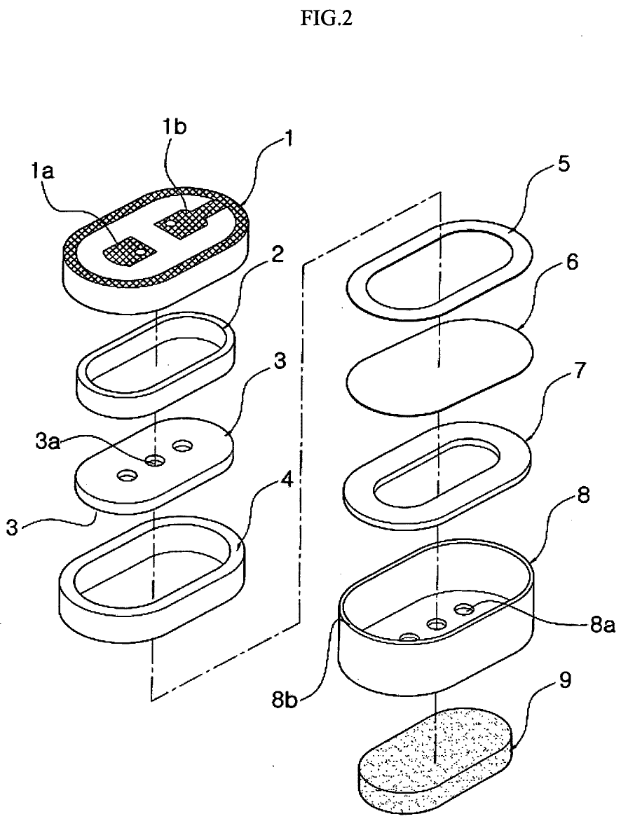

FIG. 1 is a perspective view showing a condenser microphone according to the present invention. In the condenser microphone, a diaphragm plate, a diaphragm, a spacer, a base, a backplate, a connection ring and a PCB 1 are sequentially contained in a casing 8 that is manufactured of metal, such as soft brass, in a container shape whose horizontal section has an elliptical or a running track shape, and then the uppermost edge 8b of the casing 8 is inwardly bent and secures components.

Patterns for the soldering of various elements including an FET are formed on the bottom of the PCB 1, and patterns 1a and 1b for electrical connection with the PCB of an electronic product are formed on the top of the PCB 1. In this case, the reason why through-holes are formed on the PCB 1 is to secure the FET.

The construction of the condenser microphone is described in more detail with reference to FIGS. 2 to 5 below.

The casing 8, in which a plurality of sound inlets 8a is formed through the horizontal part thereof located at the lowermost position of the casing 8 in the drawings, has an elliptical- or a running track-shaped horizontal section so as to efficiently use the rectangular space of an electronic product, such as a mobile phone or PDA, that is located at the end portion or corner of the electronic product while maintaining or increasing sensitivity compared to that of a conventional condenser microphone, when being mounted in the electronic product.

In this case, the size of the horizontal section of the casing 8, that is, the length L of the horizontal section in a longitudinal direction and the width W thereof, are set to 4.2 to 4.8 mm and 2.5 to 3.1 mm, respectively, so that the size of the condenser microphone can be minimized without influencing on the characteristics of the condenser microphone.

As for the material of the container-shaped casing 8, a conductive material, such as soft brass, can be used, and it is preferable that the surface of the casing 8 is primarily plated with nickel Ni of 2 to 3 μm and secondarily plated with gold Au of 0.02 to 0.04 μm

Of course, the diaphragm plate 7, the diaphragm 6, the spacer 6, the base 4, the backplate 3, the connection ring 2 and the PCB 1, which are contained in the casing 8, have elliptical- or running track-shaped horizontal sections like the casing 8, and the lengths and widths of the horizontal sections thereof are not greater than those of the casing 8 so as to allow the components to be contained in the casing 8.

The donut-shaped diaphragm plate 7, which is located on the horizontal surface of the casing 8 as shown in the drawings, is made of a metallic material, such as phosphor bronze, and plated with nickel of 2 to 3 μm on the surface thereof.

In particular, the diaphragm 6 that is vibrated by sound entering through the sound wave inlets 8a, that is, a film metal plate on which electric charges are accumulated, is attached to the diaphragm plate 7, so that the diaphragm 6, which is a thin plate, can be maintained at a flat state without being damaged in the process of inserting the diaphragm 6 into the casing 8.

In other words, the diaphragm plate 7, which is inserted into the casing 8 while being integrated with the diaphragm 6, functions to maintain a space inside the casing 8 so as to allow the diaphragm 6 to be vibrated by sound pressure (sound waves) entering through the sound inlets 8a, and functions to grip the outer portion of the diaphragm 6 so as to keep the diaphragm 6 flat. Furthermore, the diaphragm plate 7 functions to electrically connect the diaphragm 6 to the casing 8.

As for the material of the diaphragm 6, a film-shaped metal plate, that is, an Au-Polyethylene Terephthalate (PET) film, may be used.

The spacer 5 located on the diaphragm 6 in the drawings is made of an insulation material, such as a polyester film, and maintains an air gap between the diaphragm 6 and the backplate 3 so that the diaphragm 6 is vibrated. It is reasonable that the spacer 6 has a donut shape, in which the center portion thereof is empty, to guarantee the space to be used for the vibration of the diaphragm 6.

The backplate 3 located on the spacer 5 is made by forming an original plate made of a brass material into an elliptical or a running track shape having a plurality of perforations 3a. Nickel of 2 to 3 μm is plated on the surface of the backplate 3, and a film, on which electric charges are accumulated, is attached onto the bottom 3b of the backplate 3 opposite to the diaphragm 6.

Accordingly, since the diaphragm 6 and the film of the backplate 3 are arranged to be opposite to each other while remaining spaced apart from each other by a certain air gap, the diaphragm 6 and the backplate 3 have the same structure as a general capacitor.

Of course, the configuration or arrangement of the diaphragm 6 and the backplate 3 are not limited to the above-described case, but can be implemented in various types, such as a back type, a front type and a foil type.

The connection ring 2 and the PCB 1 sequentially stacked on the backplate 3, together with the diaphragm plate 7, the diaphragm 6, the spacer 5, the base 4 and the backplate 3, are maintained at the state of being inserted into the casing 8 by the inwardly bent uppermost edge 8a of the casing 8.

In this case, the connection ring 2 made of a metallic material, such as brass, is primarily plated with nickel of 2 to 3 μm and secondarily plated with gold Au of 0.02 to 0.04 μm and functions to electrically connect the gate of a matching FET, which is not shown in the drawings, to the backplate 3.

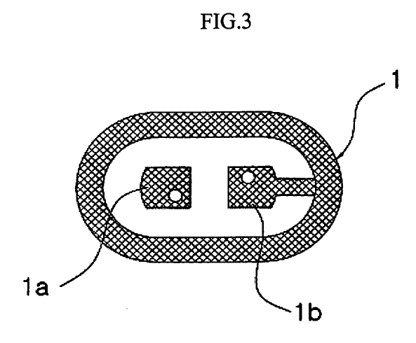

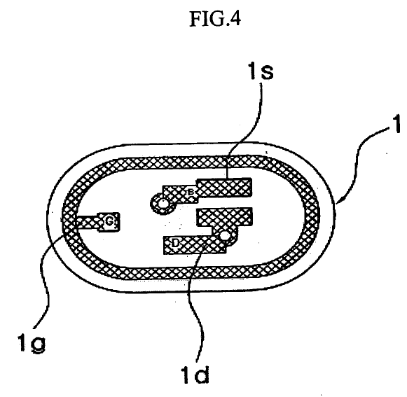

Patterns 1a and 1b made of conductive material for electrical connection with the PCB of an electronic product are formed on the top of the PCB 1 as shown in FIG. 3, and patterns 1g, 1s and 1d for the soldering of various elements including the FET are formed on the bottom of the PCB 1 as shown in FIG. 4.

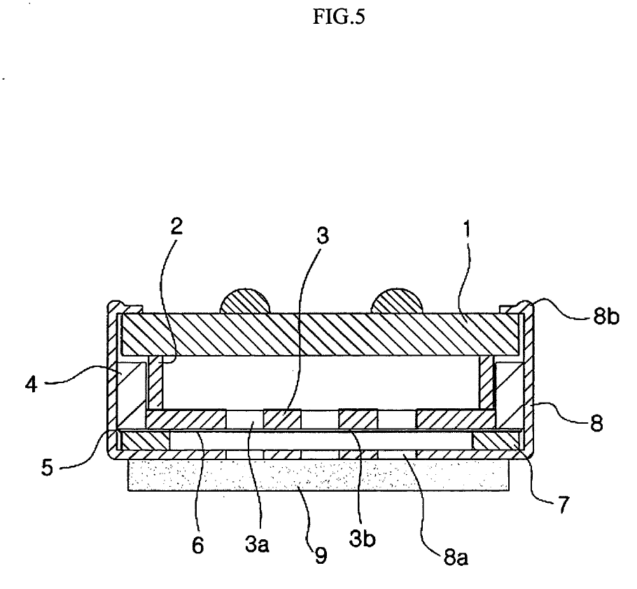

In this case, the FET functions to convert and amplify variations in electric potential, which are attributable to variations in the electrostatic capacitance between the diaphragm 6 and the backplate 3 caused by the vibrations of the diaphragm 6, into electric signals. Additionally, the base 4 made of an insulation material, such as acetyl or optical fiber, is located above the spacer 5, that is, between the casing 8 and the backplate 3 and between the casing 8 and the connection ring 2, and functions to prevent the deformation of an entire configuration while preventing the movement of the components and supporting the components so that insulation is maintained between the casing 8 and the backplate 3 and between the casing 8 and the connection ring 2 (refer to FIG. 5).

Additionally, a filter, such as a non-woven fabric, is attached to the bottom of the casing 8 through which the sound wave inlets 8a are formed, thus preventing moisture and contaminants from entering through the sound inlets 8a and therefore preventing the characteristics of the condenser microphone from being affected by the dust, moisture and contaminants.

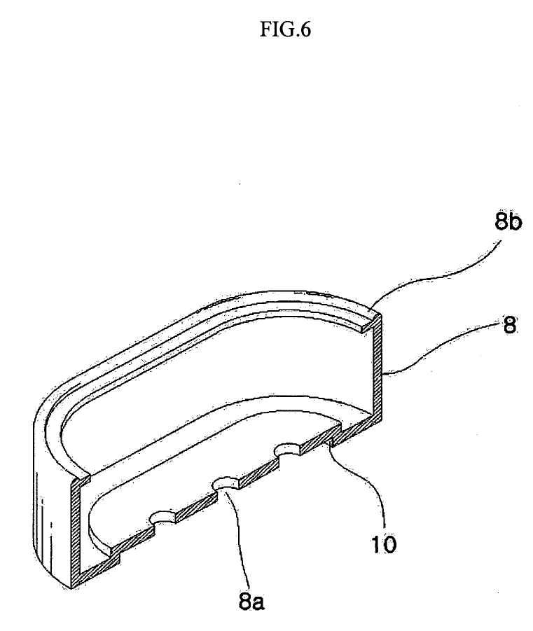

FIG. 6 is a view showing an example of a casing 8. The same reference numerals are used throughout the same construction in FIGS. 1 to 5, and detailed descriptions of the same components are omitted.

First, the casing 8 corresponding to the outer portion of the condenser microphone is made of a conductive material, such as aluminum or copper, and electrically connected to terminals, such as the diaphragm plate 7 or the pattern of the PCB 1, to function as a ground. A plurality of sound wave inlets 8a for the entry of sound is formed in the horizontal part of the casing 8. Furthermore, a raised portion 10 whose location is higher than that of the surrounding thereof is formed outside the sound wave inlets 8a, that is, at a location spaced apart from the vertical part of the casing 8 by a predetermined distance, and the raised portion 10 is adapted to prevent the horizontal part from being deformed by external pressure. The casing 8 is plated with gold Au or nickel Ni according to necessity to enhance the function of the ground. After completing a curling step that will be described later, parts except for the sound wave inlets 8a function to prevent sound from entering the inside of the condenser microphone from the outside thereof.

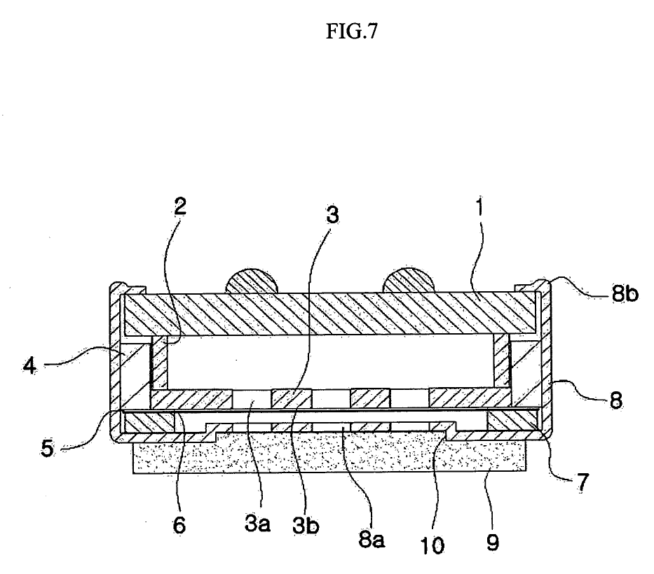

In particular, as shown in FIG. 7, since the center of the horizontal part of the casing 8 is formed to be higher than the surrounding, the gap between the diaphragm and the sound wave inlets 8a of the casing is small, so that the diaphragm can sensitively respond to externally applied sound pressure.

As shown in FIG. 7, the diaphragm plate 7 on which the diaphragm 6 is bonded, the spacer 5, the backplate 3, the connection ring 2, the base 4 and the PCB 1 are sequentially contained in the casing 8 having the above-described construction, and a curling step that is to bend an uppermost edge 8b inward is performed.

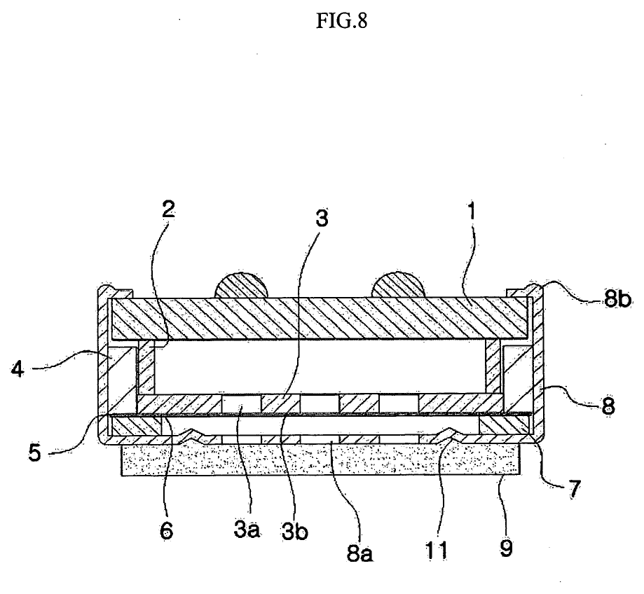

FIG. 8 is a sectional view showing another example of a casing 8 in which a groove 11 is formed on the horizontal part of the casing 8 instead of the raised portion 10 shown in FIGS. 6 and 7.

The groove 11 for preventing the deformation or characteristic variations of the casing 8, and the diaphragm plate 7 on which the diaphragm 6 is bonded, the spacer 5, the backplate 3, the connection ring 2, the base 4 and the PCB 1, in spite of external pressure applied at the time of manufacturing the condenser microphone, as in FIGS. 6 and 7, is formed on the horizontal part of the casing 8 in a circular shape while remaining spaced apart from the vertical part of the casing 8 by a predetermined distance.

In this case, the vertical section of the groove 11 formed on the horizontal part of the casing 8 may have a rectangular, triangular or arcuate shape.

Furthermore, the present invention can achieve the same effects even though the horizontal sections of the components constituting the condenser microphone, such as the casing, the diaphragm plate, the diaphragm, the spacer, the backplate, the connection ring, the base and the PCB, have various shapes, such as a circular shape or an elliptical shape. Of course, the present invention can achieve the same effects even though the type, size and arrangement of the components constituting the condenser microphone are changed.

Mode for Invention

In the condenser microphone of FIGS. 1 to 8, the diaphragm 6 is vibrated by the sound waves (sound pressure) entering through the sound inlets 8a, and therefore, the gap between the diaphragm 6 and the backplate 3 is varied, so that the electrostatic capacitance between the diaphragm 6 and the backplate 3 is varied.

Accordingly, the electric potential of the backplate 3 is varied to correspond to the sound waves and then input to the gate of the FET, so that a current flowing from the source of the FET to the drain of the FET is amplified to correspond to the sound waves.

In such a manner, the condenser microphone can convert and amplify sound waves entering through the sound wave inlets 8a into electric signals.

### INDUSTRIAL APPLICABILITY

The present invention relates to the technology of microphones that are mounted on acoustic apparatuses being used at home, various broadcasting and recording apparatuses and digital cameras, and collect voice or sound. The present invention can contribute toward the implementation of small-sized and thin apparatuses of high-quality.

1. A condenser-microphone using space efficiently and having no characteristic variations, comprising:
a metallic casing that has an elliptical-shaped horizontal section, has a container shape through which sound wave inlets are formed on a lowermost plane thereof, and has an uppermost edge inwardly bent to secure components;
a diaphragm plate that is located inside the casing, maintains a space inside the casing to allow a diaphragm to be vibrated by sound waves entering through the sound wave inlets, grips an outer portion of the diaphragm, and has an elliptical-shaped horizontal section;
a diaphragm that is located on the diaphragm plate, is vibrated by the sound waves entering through the sound wave inlets, and has a film-shaped metal plate, on which electric charges are accumulated;
a spacer made of an insulation material that is located on the diaphragm, and maintains an air gap between the diaphragm and a backplate to allow the diaphragm to be vibrated by sound waves;
a base made of an insulation material that is located on the spacer, supports the components while preventing movement of the components so that insulation is maintained between the casing and the backplate and between the casing and the connection ring, and prevents a deformation of configuration of components;
the metallic backplate that is formed in a film shape, on which electric charges are accumulated, on a side of the backplate opposite to the diaphragm, has a plurality of perforations formed therethrough, has an elliptical-shaped horizontal section, and is located inside the base to maintain a predetermined air gap with the diaphragm by the spacer;
a connection ring that is located in the base and on the backplate, and connects a gate of a matching field effect transistor (FET) to the backplate;
a printed circuit board (PCB) that has patterns made of conductive material thereon, is inserted into the casing to be electrically connected to the casing and the connection ring, and has an elliptical-shaped horizontal section; and
the FET that is attached to the PCB, converts and amplifies variations in electric potential, which is attributable to variations in electrostatic capacitance between the diaphragm and the backplate caused by vibrations of the diaphragm, into electric signals.

2. The condenser microphone according to claim 1, wherein the casing has a length L of 4.2 to 4.8 mm and a width W of 2.5 to 3.1 mm.

3. The condenser microphone according to claim 1, further comprising a filter that is located beneath the casing to prevent dust, moisture or contaminants from entering an inside of the casing through the sound wave inlets.

4. The condenser microphone according to claim 1, wherein a circular or an elliptical raised portion whose location is higher than that of a surrounding thereof is formed at a center of a horizontal part of the casing.

5. The condenser microphone according to claim 1, wherein a groove having a triangular, rectangular or arcuate shape is formed on a horizontal part of the casing while remaining spaced apart from a vertical part of the casing by a predetermined distance.
